(19) United States
(12) Patent Application Publication
(10) Pub. No.: US 2006/0157960 A1
(43) Pub. Date: Jul. 20, 2006

(54) Gas generator for air bag

(75) Inventors: Naoki Matsuda, Himeji-Shi (JP); Atsushi Hatomoto, Himeji-Shi (JP)

Correspondence Address: BIRCH STEWART KOLASCH & BIRCH, PO BOX 747, FALLS CHURCH, VA, 22040-0747, US

(73) Assignee: Daicel Chemical Industries, Ltd., Sakai-Shi (JP)

(21) Appl. No.: 11/312,501

(22) Filed: Dec. 21, 2005

Related U.S. Application Data
(60) Provisional application No. 60/639,309, filed on Dec. 28, 2004.

(30) Foreign Application Priority Data
Dec. 22, 2004 (JP) 2004-371382

(51) Int. Cl. B60R 21/26

(52) U.S. Cl. 280/736; 280/741

(57) ABSTRACT

The present invention provides a gas generator for an air bag, comprising: a housing forming an outer container, the housing including a plurality of cylindrical members that are arranged in alignment with one another; an ignition device that is ignited by an ignition current, provided in the housing and a gas generating source provided within the housing and generating gas for inflating the air bag; a connecting member for fixing and integrating the plurality of cylindrical members to each other; and a gas discharge port provided in at least one of the connecting member and the plurality of cylindrical members, wherein an interior spaces of the plurality of cylindrical members communicate with each other by the connecting member to thereby form a continuous space in the interior of the housing.

### CROSS-REFERENCE TO RELATED APPLICATIONS

This nonprovisional application claims priority under 35 U.S.C. § 119(a) on Patent Application No. 2004-371382 filed in Japan on 22 Dec. 2004 and 35 U.S.C. § 119(e) on U.S. Provisional Application No. 60/639309 filed on 28 Dec. 2004, which are incorporated by reference.

### BACKGROUND OF THE INVENTION

1. Technical Field

The present invention relates to a gas generator for an air bag used as a safety device in a vehicle, and an air bag module and an air bag apparatus using this gas generator. More particularly, the present invention relates to a gas generator for an air bag having an improved overall form, and an air bag module and air bag apparatus using this gas generator.

2. Description of the Related Art

Conventionally, various air bag apparatuses are installed in vehicles to protect the passengers from the impact of a collision. When constructing the air bag apparatus, an air bag module having an air bag and a gas generator disposed inside a module case is typically used.

The gas generator used in the manufacture of this air bag module has a substantially fixed form corresponding to its disposal position. For example, for a driver side, the gas generator takes a disk shape which is shorter in the axial direction, and for a front passenger side, the gas generator takes a cylindrical form which is longer in the axial direction. Accordingly, the module case accommodating the gas generator is formed in a shape which corresponds to the various different forms of the gas generator.

However, surplus space exists in the interior of the module case as well as the space occupied by the gas generator, and therefore the entire module case is bulky, leading to a problem regarding attachment space. In the case of an air bag module disposed on the front passenger side in particular, the inflator takes a cylindrical form which is longer in the axial direction, and is disposed inside the module case horizontally, and therefore the module case requires a height (thickness) which at least corresponds to the outer diameter of the housing.

In the gas generator disclosed in U.S. Pat. No. 6,227,562 the arrangement of a gas generator in a module case is disclosed. In an inflator described in this document, two independent gas generators are disposed in an inflator assembly.

### SUMMARY OF THE INVENTION

The present invention provides a gas generator for an air bag, comprising:
a housing forming an outer container, the housing including a plurality of cylindrical members that are arranged in alignment with one another;
an ignition device that is ignited by an ignition current, provided in the housing and
a gas generating source provided within the housing and generating gas for inflating the air bag;
a connecting member for fixing and integrating the plurality of cylindrical members to each other; and
a gas discharge port provided in at least one of the connecting member and the plurality of cylindrical members,
wherein an interior spaces of the plurality of cylindrical members communicate with each other by the connecting member to thereby form a continuous space in the interior of the housing.

The housing may be composed by a plurality of cylindrical members comprising the gas source and a connecting member for fixing and integrating the plurality of cylindrical members to each other.

The plurality of cylindrical members are arranged in alignment with one another. The alignment means an arrangement of the cylindrical members connected with one another by way of the connecting member in some ways, for example, in alignment with one another or in alignment. Moreover the cylindrical members may be located so that the central axes thereof extend in different directions.

The present invention also provides a gas generator for an air bag, comprising:
a housing forming an outer container, the housing being formed in a columnar, hollow body having a flattened shape;
an ignition device that is ignited by an ignition current, provided in the housing; and
a gas generating source which generates gas for inflating the air bag, provided in the housing.

The present invention also provides an air bag module comprising:
an air bag which inflates when expansion gas is introduced therein;
a gas generator for generating the expansion gas; and
a module case housing the gas generator,
wherein the gas generator is the above mentioned gas generator for an air bag.

The present invention also provides an air bag apparatus comprising:
an air bag which inflates when expansion gas is introduced therein; and
a gas generator for generating the expansion gas,
wherein the gas generator is the above mentioned gas generator for an air bag.

The present invention also provides an air bag module comprising:
an air bag which inflates when expansion gas is introduced therein;
a gas generator for generating the expansion gas; and
a module case housing the gas generator,
wherein the gas generator is the above mentioned gas generator for an air bag.

The present invention also provides an air bag apparatus comprising:
an air bag which inflates when expansion gas is introduced therein; and
a gas generator for generating the expansion gas,
wherein the gas generator is a the above mentioned gas generator for an air bag.

### BRIEF DESCRIPTION OF THE DRAWINGS

The present invention will become more fully understood from the detailed description given hereinbelow and the accompanying drawings which are given by way of illustration only, and thus are not limitative of the present invention and wherein: FIG. 1 shows an axial sectional view of a gas generator for an air bag according to an embodiment;

FIG. 2 shows an axial sectional view of a gas generator for an air bag according to another embodiment;

FIG. 3 shows an axial sectional view of a gas generator for an air bag according to still another embodiment;

FIG. 4 shows an axial sectional view of a gas generator for an air bag according to still another embodiment;

FIG. 5 shows an axial sectional view of a gas generator for an air bag according to still another embodiment;

FIG. 6 shows a schematic axial sectional view showing an air bag module according to an embodiment; and

FIG. 7 shows a schematic axial sectional view showing an air bag apparatus according to an embodiment.

### DETAILED DESCRIPTION OF THE INVENTION

The present invention provides a gas generator for an air bag which can be used in a compact air bag module and a compact air bag apparatus while exhibiting a sufficient operating performance.

The present invention also provides a gas generator for an air bag which takes a flattened form while providing a sufficient housing interior volume.

The present invention further provides a gas generator for an air bag which can eliminate surplus space when accommodated in a module case, enabling the use of a compact module case.

The present invention further provides a gas generator which allows an increase in the compactness of an air bag module when the gas generator is incorporated into an air bag system (module case), and which is easier to manufacture when considered as a gas generator.

As a method of solving the problems described above, the present invention provides a gas generator in which a plurality of small-diameter cylinder housings are arranged in alignment with each other, thus providing an identical volume to the volume obtained in a housing having a single, large-diameter cylinder, and in which the plurality of cylinder housings communicate with each other. Hence, the diameter of each housing can be reduced, and the height of the gas generator (any length perpendicular to the axial direction) can be suppressed while the inner volume thereof remains the same. By incorporating the gas generator into a module case, the overall height of the module case can be reduced, and hence a compact, non-bulky module case can be used and a compact air bag module can be produced.

The cylindrical members of the housing may take an annular or polygonal annular sectional form perpendicular to the axial direction, and are formed such that at least a space for accommodating the gas generating source can be secured. When the cylindrical members are connected to each other by the connecting member to form the housing, the interiors thereof are connected to each other so that a single, continuous space can be formed. In other words, the connecting member is formed as a member for communicating the interior spaces of the cylindrical members with each other as well as connecting the cylindrical members themselves to each other. For example, as the connecting member, a cylindrical member or a communicating hole formed in the connection part between the cylindrical members may be used. Further, adjacent cylindrical members may be connected at a plurality of parts, and in this case also, at least one connecting member for communicating the interior spaces of the adjacent cylindrical members with each other should be formed. Hence in the present invention, the cylindrical members that are connected by the connecting member may also be connected by another member.

In the housing formed by fixing and integrating at least two cylindrical members using the connecting member as described above, when cylindrical members having a form which is longer in the axial direction are arranged in alignment with one another, the housing takes an overall flattened form. In other words, the housing extends in the direction in which the cylindrical members are arranged. Note that the housing of the present invention has a substantially identical inner volume to that of a conventional gas generator including a single, large-diameter housing, but takes a flattened form, and as a result, an overall non-bulky gas generator is provided.

In the gas generator of the present invention, the plurality of cylindrical members are arranged in alignment with one another, and it is preferable that one cylindrical member be disposed adjacent to the other cylindrical member such that the central axis of one cylindrical member exists within the projected range of the height (diameter) of the other cylindrical member when viewing the axial cross-section of the adjacent cylindrical members. Note, however, that it is acceptable the adjacent cylindrical members may be arranged such that the central axes thereof are slightly staggered.

The ignition device may be provided in each of the plurality of cylindrical members, or in at least one of the cylindrical members. The interior of the housing may be charged with a solid gas generating agent alone, pressurized gas alone, or both a solid gas generating agent and pressurized gas, and this may be varied among the plurality of cylindrical members. When a different gas generating source is charged into each cylindrical member, pressurized gas alone may be charged into one of the cylindrical members, and pressurized gas and a solid gas generating agent may be charged into the other cylindrical member, for example.

In consideration of the structural feature of the present invention according to which a single, continuous space is formed in the interior space of the housing, it is preferable that at least a pressurized gas having fluidity be used as the gas generating source. When a pressurized gas having fluidity is used, the pressurized gas can be spread throughout the entire housing interior simply by charging the pressurized gas into one of the cylindrical members during manufacture of the gas generator. In other words, unlike the prior art, in which gas generators are assembled individually and incorporated into a module case, an easily assembled gas generator can be provided.

The gas discharge port may be formed in any part of the cylindrical member or any part of the connecting member, and may be formed in one or more parts. When pressurized gas is used as an inflating medium serving as the gas generating source, a structure in which the gas discharge port is sealed by a rupturable plate and the rupturable plate is ruptured directly by the ignition device may be employed. Alternatively, a method in which a solid gas generating agent is ignited and burned by the ignition device, and the resultant combustion gas raises the internal pressure of the housing such that the rupturable plate is ruptured, may be employed.

In the gas generator for an air bag according to the present invention, the plurality of cylindrical members are preferably formed with a substantially identical outer diameter. By forming the outer diameters of the cylindrical members to have an identical outer diameter, an overall housing shape with few irregularities can be provided. In other words, when the outer diameters are different, the module case and so on have to be designed taking the height of the gas generator as the height of the part having the largest diameter, leading to an increase in the overall height and difficulties in securing the required disposal space.

Further, in the gas generator for an air bag according to the present invention, each of the plurality of cylindrical members fixed and integrated by the connecting member preferably exists on the same plane. The phrase “each of the plurality of cylindrical members exists on the same plane” means that the central axis of each of the plurality of cylindrical members fixed and integrated by the connecting member is disposed to extend on the same plane, or that at least one of the cylindrical members is disposed so as not to protrude from the space in which the other cylindrical member exists, for example. When disposing the cylindrical members on the same plane, the cylindrical members may be disposed with aligning or intersecting orientations, and the central axis of each cylindrical member may extend in any direction. Hence, the extension direction of the central axis of the cylindrical member, or in other words the orientation of each cylindrical member, may be set appropriately in accordance with the disposal position of the gas generator. By disposing the cylindrical members in this manner, irregularities in the housing can be suppressed as a whole, similarly to the above case in which the plurality of cylindrical members are formed with a substantially identical outer diameter. Moreover, since each cylindrical member exists on the same plane, the housing and gas generator formed using the cylindrical members take an overall flattened form.

Further, in the gas generator for an air bag according to the present invention, all of the plurality of cylindrical members are preferably aligned in an identical axial direction, and fixed and integrated thus by the connecting member. By aligning the central axis orientation of each cylindrical member, the housing and gas generator take an overall flattened and converged form, thus providing an even more compact gas generator.

Further, in the gas generator for an air bag according to the present invention, the gas discharge port is preferably disposed in a different position to the ignition device. In so doing, a lead wire extending from the igniter is unlikely to interfere with the air bag when the air bag is connected. Hence, the gas generator can be connected to the air bag easily, and the entire module can be simplified. Here, the phrase “the gas discharge port is disposed in a different position to the ignition device” means that the lead wire connected to the ignition device is sufficiently removed from the air bag to ensure that the lead wire does not impinge on the air bag when the air bag is connected to the gas discharge port, and may include a case in which the ignition device and gas discharge port are formed in opposite positions in the axial direction of the housing, a case in which the ignition device is formed at one end portion in the axial direction of the housing while the gas discharge port is formed in the side face portion of the housing, a case in which the ignition device is formed in the side face portion of the housing while the gas discharge port is formed in one end portion in the axial direction of the housing, and a case in which the ignition device and gas discharge port are formed at the same end portion or side face portion of the housing but at a remove from each other, for example.

Further, in the gas generator for an air bag according to the present invention, the ignition device may be formed such that at least one ignition device exists in the cylindrical member positioned furthest away from the gas discharge port. Hence, by activating the ignition device in the cylindrical member positioned furthest away from the gas discharge port, the gas source (in particular, pressurized gas) in all of the cylindrical members forming the housing can be guided efficiently toward the gas discharge port.

The aforementioned flattened form is a substantially level form with few irregularities, and may include a sectional form perpendicular to the axial direction of the columnar housing, having different width and height dimensions, or a rectangular sectional form, for example.

By forming the housing to be hollow in this manner, members such as the ignition device and gas generating source can be accommodated therein, and since the housing takes a flattened form, the space in the module case can be used effectively, and the air bag module and air bag apparatus can be made compact. In consideration of these points, it is preferable that the gas generating source, such as pressurized gas, be disposed directly in the interior of the flattened housing.

As a further method of solving the problems described above, the present invention provides an air bag module and an air bag apparatus formed using the gas generator for an air bag according to the present invention.

In the air bag module of the present invention, the gas generator for an air bag according to the present invention is used, and this gas generator includes a plurality of cylindrical members while having the same volume as a conventional gas generator, leading to an increase in the curvature (a decrease in the curvature radius) of the housing such that less dead space is formed. Conventionally, a housing with a single large diameter is used, leading to a decrease in the curvature (an increase in the curvature radius) of the housing such that when the gas generator is incorporated into a module case, dead space is inevitably formed between the two members. Moreover, the housing of the gas generator used in the air bag module of the present invention has a flattened form and a small outer diameter (the part that corresponds to the thickness of the flattened housing). Hence, the entire air bag module also takes a flattened form, enabling reductions in the overall thickness and size of the module.

Likewise, the gas generator used in the air bag apparatus formed in this manner includes a plurality of cylindrical members while having the same volume as a conventional gas generator, and the housing thereof has a flattened form with a smaller outer diameter (the part that corresponds to the thickness of the flattened housing). Hence, an air bag apparatus having an air bag gas generator that can be disposed in a small space is realized.

### EMBODIMENTS OF THE INVENTION

Preferred embodiments of the present invention will be described below on the basis of the drawings.

### Embodiment 1

FIG. 1 shows an axial sectional view of an air bag gas generator 10 according to this embodiment.

In the air bag gas generator 10 shown in the drawing, two cylindrical members 12a, 12b are joined to a connecting member 11 having a space portion 13 formed in the interior thereof, two ignition devices 14a, 14b are disposed in the space portion 13 of the connecting member 11 in the axial extension direction of each cylindrical member 12a, 12b,gas generating agents 15a, 15b are provided in the vicinity of the ignition devices 14a, 14b, respectively, an interior space 16 of the two cylindrical members 12a, 12b communicates with the interior space 13 of the connecting member 11, and pressurized gas is charged into this interior space 16.

The air bag gas generator 10 will be described in detail below, but for convenience, the cylindrical member on the left side of the drawing will be referred to hereafter as a first cylindrical member 12a, the cylindrical member on the right side will be referred to as a second cylindrical member 12b, the ignition device on the left side of the drawing will be referred to as a first ignition device 14a (in this embodiment, a first igniter 14a), the ignition device on the right side will be referred to as a second ignition device 14b (in this embodiment, a second igniter 14b), the gas generating agent on the left side of the drawing will be referred to as a first gas generating agent 15a, and the gas generating agent on the right side will be referred to as a second gas generating agent 15b.

A housing (H) of the gas generator 10 of this embodiment includes the two cylindrical members 12a, 12b having circular cross-sections, and the connecting member 11 to which the two cylindrical members are joined. The two cylindrical members 12a, 12b both have one closed end portion and one open end portion, and a gas opening 17 is formed in the closed end portion of one of the cylindrical members 12. The gas opening is sealed by a rupturable plate 18. The connecting member 11 accommodates the two ignition devices (the igniters 14a, 14b), and has the space portion 13 which communicates the two cylindrical members 12a, 12b with each other.

The open end portions of the two cylindrical members 12a, 12b are welded to the common connecting member 11 to form a single overall housing (H). A single, continuous space spanning the two cylindrical members 12a, 12b and the connecting member 11 is formed in the interior of the housing (H). In this embodiment, pressurized gas is charged into the interior space 16 of the housing (H). When the pressurized gas is to be charged, the interior of the housing (H) is a single, continuous space, and therefore the pressurized gas can be charged into the entire interior of the housing (H) by charging the pressurized gas into either one of the two cylindrical members 12a, 12b or into the connecting member 11. In this embodiment, a charging hole is formed in the peripheral wall portion of one of the two cylindrical members 12a, 12b, and a sealing pin (P) is welded and fixed into the charging hole.

In this embodiment, the gas opening 17 is formed in the closed end portion of the first cylindrical member 12a, and a diffuser (D) having a gas discharge port(s) (D1) formed in its peripheral wall surface is mounted on the first cylindrical member 12a to cover the gas opening 17. In other words, in this embodiment the gas discharge port (D1) is provided in the first cylindrical member 12a. To prevent pressurized gas discharge or leakage from the gas discharge port (D1) prior to activation of the gas generator 10, the gas opening 17 is sealed by the rupturable plate 18.

The igniters 14a, 14b are attached to the connecting member 11 in positions corresponding to each of the two cylindrical members 12a, 12b (in this embodiment, positions in the axial extension direction of the cylindrical members 12) as ignition devices, and the gas generating agents 15a, 15b are disposed adjacent to the igniters 14a, 14b. More specifically, the gas generating agents 15a, 15b are accommodated in a combustion chamber housing (H2) forming a combustion chamber, and a large number of communication holes are formed in the peripheral wall portion of the combustion chamber housing (H2) such that the combustion chamber housing (H2) communicates with the interior spaces 16a, 16b at any timing during activation of the gas generator.

In the gas generator 10 according to this embodiment, a regulating member 19 for regulating gas movement between the cylindrical members 12 is formed in the interior space 13 of the connecting member 11. In a case such as that to be described below, in which the first igniter 14a alone is activated first and the gas charged into the first cylindrical member 12a is discharged through the gas discharge port (D1) preferentially, for example, the regulating member 19 serves to regulate discharge of the pressurized gas existing in the second cylindrical member 12b, and hence the regulating member 19 forms a narrow path for regulating the flow of gas between the interior space 16 of the first cylindrical member 12aand the interior space 16 of the second cylindrical member 12b.

In the gas generator 10 formed as described above, upon activation of one or both of the igniters 14a, 14b, the gas generating agent 15a/15b corresponding to the activated igniter 14a/14b burns, and the internal pressure of the housing (H) is raised by the resultant combustion gas and heat. This increase in internal pressure ruptures the rupturable plate 18 such that the pressurized gas inside the housing (H) can be discharged through the gas discharge port (D1). The operating pattern (gas discharge pattern) of the gas generator 10 may be adjusted by deciding which one of the igniters 14a, 14b is to be ignited or the timing at which the igniters 14a, 14b are activated, and hence the operating pattern can be adjusted appropriately in accordance with the magnitude of the impact generated by the collision, for example. More specifically, the igniters 14a, 14b may be activated in the following patterns, for example.
(1) Only the first igniter 14a is activated.
(2) The first igniter 14a and second igniter 14b are activated simultaneously.
(3) The first igniter 14a is activated first, and after a fixed time period, the second igniter 14b is activated.

To describe an operation of the gas generator 10 based on the pattern (3) among the above patterns (1) to (3), upon impact, the first igniter 14a is activated first, burning the adjacent gas generating agent 15a. The internal pressure of the housing (H) is raised by the gas that is generated at this time, thereby rupturing the rupturable plate 18. A part of the pressurized gas (or combustion gas that is generated by the gas generating agent 15a burned upon activation of the first igniter 14a) in the interior of the housing (H) passes through the opening, and is discharged to the outside of the housing (H) through the gas discharge port (D1) formed in the diffuser (D). Next, upon activation of the second igniter 14b, the gas generating agent 15 adjacent to the second igniter 14b is burned similarly, generating additional gas. This gas is then discharged from the diffuser (D), together with pressurized gas remnants when such remnants remain in the interior of the housing (H). In this embodiment in particular, the regulating member 19 is provided in the connecting member 11 for regulating the flow of gas from the second cylindrical member 12b toward the first cylindrical member 12a, and the narrow path formed by the regulating member 19 regulates the flow of the remaining pressurized gas and the combustion gas of the second gas generating agent 15b toward the diffuser (D) at the time of activation of the second igniter 14b. In other words, the regulating member 19 functions to regulate the amount of additional gas that is generated after activation of the first igniter 14a. When considered in these terms, the gas generator 10 may be provided as a gas generator including the two cylindrical members 12a, 12b and using only the first igniter 14a and the gas generating agent 15 burned thereby, without using the second igniter 14b and the adjacent gas generating agent 15b.

### Embodiment 2

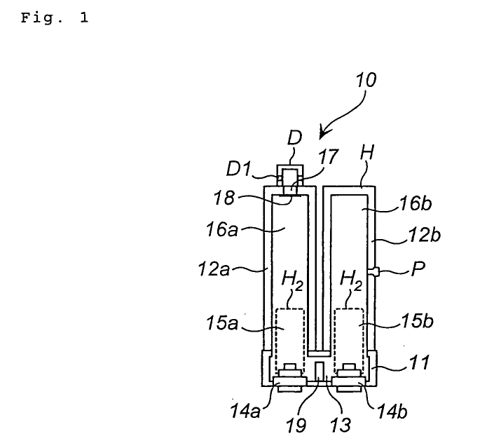

FIG. 2 shows an axial sectional view showing an air bag gas generator 20 according to another embodiment. In this embodiment (FIG. 2), members in FIG. 2 exhibiting identical functions and actions to those shown in FIG. 1 have been allocated reference numerals obtained by adding ten to the corresponding reference numeral in FIG. 1.

The air bag gas generator 20 shown in FIG. 2 uses three cylindrical members 22a, 22b, 22c integrated with a single connecting member 21 to form the housing (H). In other words, in the air bag gas generator 20 of this embodiment, the three cylindrical members 22a, 22b, 22c are connected in alignment with the connecting member 21, and two igniters 24a, 24b are provided in an interior space 23 of the connecting member 21 in the axial extension direction of the cylindrical members 22 existing on the two ends. A gas opening 27 is formed in the closed end portion of the cylindrical member (first cylindrical member 22) furthest to the left of the drawing, and similarly to the gas generator 10 shown in FIG. 1, the diffuser (D) comprising the plurality of gas discharge ports (D1) is mounted on the gas opening 27. Note that in the gas generator 20 formed using the three cylindrical members 22a, 22b, 22c in this manner, the gas opening 27 and diffuser (D) may be formed at the closed end portion of the central cylindrical member (second cylindrical member 22).

In the gas generator 20 of this embodiment also, the housing (H) formed by the three cylindrical members 22a, 22b, 22c and single connecting member 21 takes a flattened form with pressurized gas charged into the interior. The operating performance (the degree and timing of gas discharge) of the gas generator 20 can be adjusted arbitrarily by deciding which one of the igniters 24a, 24b is to be activated and the timing at which the igniters 24a, 24b are activated.

### Embodiment 3

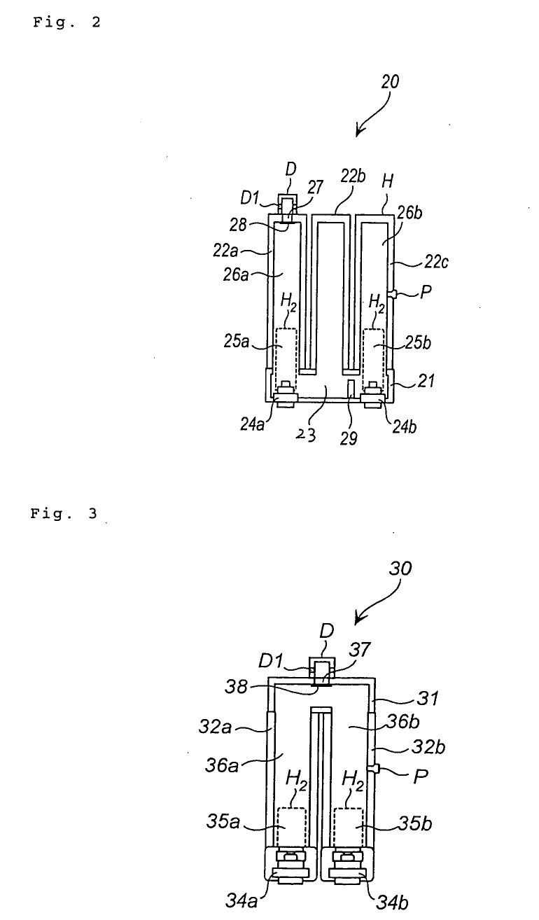

FIG. 3 shows an axial sectional view showing an air bag gas generator 30 according to still another embodiment. In this embodiment (FIG. 3), members in FIG. 3 exhibiting identical functions and actions to those shown in FIG. 1 have been allocated reference numerals obtained by adding twenty to the corresponding reference numeral in FIG. 1.

The air bag gas generator 30 shown in FIG. 3 is similar in its basic structure to that of the Embodiment 1 (FIG. 1), but differs therefrom in the formation positions of igniters 34a, 34b (and gas generating agents 35a, 35b) and a gas opening 37 (and the diffuser (D)). More specifically, in the gas generator 10 shown in FIG. 1, the two igniters 14a, 14b (and gas generating agents 15a, 15b) are provided in the space portion 13 in the interior of the connecting member 11, and the gas discharge ports (D1) are formed in the closed end portion of the cylindrical member 12, whereas in the gas generator 30 of the Embodiment 3 (FIG. 3), the igniters 34a, 34b (and gas generating agents 35a, 35b) are provided in the closed end portions of the cylindrical members 32a, 32b respectively, and the gas discharge ports (D1) are formed in the connecting member 31.

In the gas generator 30 formed in this manner, the housing (H) includes the two cylindrical members 32a, 32b and the connecting member 31 which connects the two cylindrical members 32a, 32b. By activating one or both of the igniters 34a, 34b provided in the end portions of the respective cylindrical members 32a, 32b, the corresponding gas generating agent 35a/35b bums, thereby raising the internal pressure of the housing (H) so that the rupturable plate 18 is ruptured, and thus the pressurized gas can be discharged through the gas discharge ports (D1). The housing (H) and gas generator 30 formed in this manner have a substantially flattened form, and therefore the required disposal space in a module case, vehicle, or the like can be reduced.

### Embodiment 4

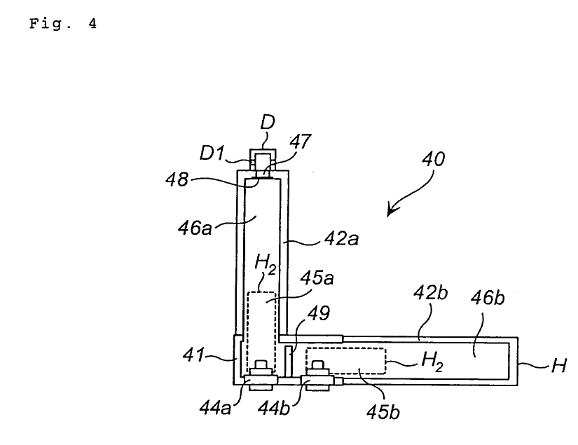

FIG. 4 shows an axial sectional view showing an air bag gas generator 40 according to still another embodiment. In this embodiment (FIG. 4), members in FIG. 4 exhibiting identical functions and actions to those shown in FIG. 1 have been allocated reference numerals obtained by adding thirty to the corresponding reference numeral in FIG. 1.

In the air bag gas generator 40 shown in FIG. 4, two cylindrical members 42a, 42b are arranged such that the respective central axes thereof extend in different directions, and the two cylindrical members 42a, 42b are connected to a connecting member 41 to form the housing (H). Igniters 44a, 44b are disposed in cylindrical members 42a, 42b, respectively, and gas generating agents 45a, 45b are provided for igniters 44a, 44b, respectively.

In other words, in the gas generator 40 of Embodiment 4, the two cylindrical members 42a, 42b are disposed with perpendicular axes, the connecting member 41 is disposed at the intersecting part thereof, a space portion 43 is formed in the connecting member 41, the two igniters 44a, 44b are disposed in the space portion 43, and an interior space 46 of the two cylindrical members 42a, 42b is communicated with each other via the space portion 43. The gas generator 40 formed in this manner substantially corresponds to the gas generator 10 of Embodiment 1 (FIG. 1) with the right side cylindrical member (second cylindrical member 42) rotated 90° clockwise.

In the gas generator 10 shown in FIG. 4 also, pressurized gas is charged into the housing (H), and the operating performance (the degree and timing of gas discharge) of the gas generator 40 can be adjusted arbitrarily by deciding which one of the igniters 44a, 44b is to be activated and the timing at which the igniters 44a, 44b are activated.

The gas generator 40 and housing (H) formed in this manner have an overall flattened form (in other words, a form with suppressed height), and therefore the required disposal space in a module case, vehicle, or the like can be reduced.

### Embodiment 5

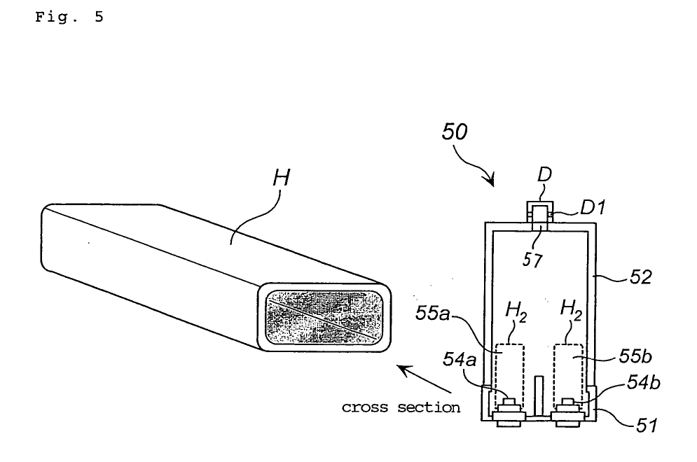

FIG. 5 shows an axial sectional view showing an air bag gas generator 50 according to still another embodiment. In this embodiment (FIG. 5), members in FIG. 5 exhibiting identical functions and actions to those shown in FIG. 1 have been allocated reference numerals obtained by adding forty to the corresponding reference numeral in FIG. 1.

In the gas generator shown in the drawing, a cylindrical body having a rectangular axial cross-section is used as a housing, a gas outlet is formed in a closed end portion side (the upper end side of the drawing) thereof, and a closing member accommodating two ignition devices (igniters) is provided on an open side end portion (the lower end side of the drawing) thereof.

The diffuser (D) having the gas discharge port (D1) formed in its peripheral wall surface is mounted on the gas outlet formed in the closed end portion side (the upper end side of the drawing) of the housing so as to cover a gas opening 57 serving as the gas outlet. To prevent pressurized gas discharge or leakage from the gas discharge ports (D1) before activation of the gas generator 50, the gas opening 57 is sealed by a rupturable plate 58.

Further, the two ignition devices (igniters) provided in the closing member for closing the open side end portion of the housing (H) are provided with gas generating agents 55a, 55b charged into the respective combustion chamber housings (H2), and each of the gas generating agents 55a, 55b are ignited and burned upon activation of the corresponding igniters 54a, 54b.

The housing (H) and gas generator 50 formed in this manner have an overall flattened form, and therefore the required disposal space in a module case, vehicle, or the like can be reduced.

### Embodiment 6

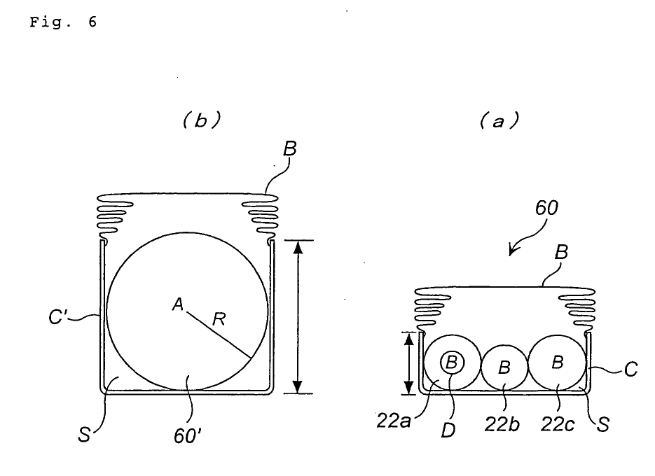

FIG. 6(a) shows a schematic axial sectional view showing an air bag module formed using the gas generator for an air bag according to the present invention. In particular, FIG. 6(a) illustrates an air bag module formed by incorporating the gas generator 20 shown in FIG. 2 and an air bag (B) into a module case (C).

In the air bag module shown in the drawing, the gas generator 20, having a flattened shape in which the housing (H) includes the three cylindrical members 22a, 22b, 22c, as shown in FIG. 2, is used as the gas generator 20, and assuming that the inner volume of each cylindrical member 22a/22b/22c is B, the overall interior volume of the housing (H) is 3B. Meanwhile, FIG. 6(b) illustrates an air bag module in which a conventional cylindrical gas generator 20′ and an air bag (B′) are incorporated into a module (C′). When an attempt is made to secure an equal inner volume 3B in this gas generator 20′ to that of the gas generator 20 shown in FIG. 6(a), the outer diameter of the gas generator 20′ increases, and since the curvature thereof is small (in other words, a curvature radius R is large), dead space (S) is formed in the corner parts of the module case.

In contrast, in the gas generator 20 according to the present invention, which is shown in FIG. 6(a), the three cylindrical members 22a, 22b, 22c each having a small diameter are arranged horizontally, and therefore, while an equal inner volume to that of the gas generator 20′ shown in FIG. 6(b) is secured, the outer diameter of the gas generator 20 can be suppressed to approximately 0.58 times that of the gas generator 20′ shown in FIG. 6(b) (when the length in the housing axis direction is equal).

Furthermore, since the outer diameter of each cylindrical member 22a/22b/22c is small, the dead spaces (S) formed in the comers of the module case (C) are small, and moreover, the gas generator 20 takes an overall flattened, thin shape. Hence, the air bag module is also thin and not bulky, and therefore less likely to be subjected to attachment space restrictions.

### Embodiment 7

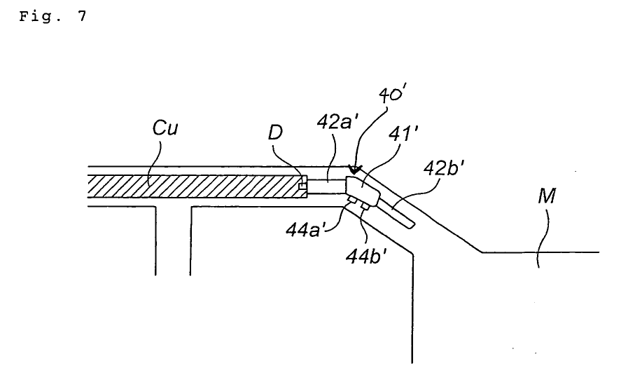

FIG. 7 is an enlarged schematic view of the main parts of an air bag apparatus formed using the gas generator for an air bag according to the present invention. The air bag apparatus shown in the drawing is an inflator apparatus for a curtain air bag formed identically to the gas generator 40 of Embodiment 4 (FIG. 4), using a gas generator 40′ in which the two cylindrical members 42a, 42b are integrated at intersecting orientations. More specifically, the gas generator 40′ corresponds to the gas generator 40 shown in FIG. 4 with the attachment angle of one of the cylindrical members 42 widened even further, and the connecting member 41 fixed thereto. The two cylindrical members 42a′, 42b′ are disposed in the gas generator 40′ in an arrangement which conforms with a C pillar (a pillar existing to the rear of the cabin interior) and a ceiling portion of a vehicle (M).

Typically, when a curtain air bag apparatus is disposed, the gap between the vehicle and passenger is restricted, and there are often further restrictions on the attachment space. At the same time, it is difficult to provide a curved portion in a single cylindrical member, and hence it is difficult to secure sufficient disposal space for the gas generator. In the air bag apparatus shown in FIG. 7, by joining the two cylindrical members 42a′, 42b′ in a curved form using the connecting member 41′ and disposing the gas generator 40′ in accordance with the angle formed by the pillar and ceiling portion, an introduction pipe for connecting the gas generator 40 to the curtain bag (Cu) can be omitted, and the bag (Cu) can be connected directly to the diffuser (D). Hence, an air bag apparatus which eliminates problems regarding disposal space and reduces the length of a gas introduction passage such that gas is generated rapidly can be provided.

The invention thus described, it will be obvious that the same may be varied in many ways. Such variations are not to be regarded as a departure from the spirit and scope of the invention, and all such modifications as would be obvious to one skilled in the are intended to be included within the scope of the following claims.

1. A gas generator for an air bag, comprising:
a housing forming an outer container, the housing including a plurality of cylindrical members that are arranged in alignment with one another;
an ignition device that is ignited by an ignition current, provided in the housing and
a gas generating source provided within the housing and generating gas for inflating the air bag;
a connecting member for fixing and integrating the plurality of cylindrical members to each other; and
a gas discharge port provided in at least one of the connecting member and the plurality of cylindrical members,
wherein an interior spaces of the plurality of cylindrical members communicate with each other by the connecting member to thereby form a continuous space in the interior of the housing.

2. The gas generator for an air bag according to claim 1, wherein the plurality of cylindrical members have a substantially identical outer diameter to one another.

3. The gas generator for an air bag according to claim 2, wherein the plurality of cylindrical members fixed and integrated by the connecting member exist on the same plane.

4. The gas generator for an air bag according to claim 3, wherein all of the plurality of cylindrical members are aligned in an identical axial direction to one another, and fixed and integrated thus by the connecting member.

5. The gas generator for an air bag according to claim 1, wherein the gas discharge port is disposed at a different position from the ignition device.

6. A gas generator for an air bag, comprising:
a housing forming an outer container, the housing being formed in a columnar, hollow body having a flattened shape;
an ignition device that is ignited by an ignition current, provided in the housing; and
a gas generating source which generates gas for inflating the air bag, provided in the housing.

7. The gas generator for an air bag according to claim 6, wherein a sectional form of the housing, perpendicular to the axial direction thereof, has different width and height in dimension from each other.

8. The gas generator for an air bag according to claim 7, wherein the sectional form of the housing, perpendicular to the axial direction thereof, is rectangular.

9. An air bag module comprising:
an air bag which inflates when expansion gas is introduced therein;
a gas generator for generating the expansion gas; and
a module case housing the gas generator,
wherein the gas generator is a gas generator for an air bag according to claim 1.

10. An air bag apparatus comprising:
an air bag which inflates when expansion gas is introduced therein; and
a gas generator for generating the expansion gas,
wherein the gas generator is a the gas generator for an air bag according to claim 1.

11. An air bag module comprising:
an air bag which inflates when expansion gas is introduced therein;
a gas generator for generating the expansion gas; and
a module case housing the gas generator,
wherein the gas generator is a gas generator for an air bag according to claim 6.

12. An air bag apparatus comprising:
an air bag which inflates when expansion gas is introduced therein; and
a gas generator for generating the expansion gas,
wherein the gas generator is a the gas generator for an air bag according to claim 6.
